(19) United States
(12) Patent Application Publication
(10) Pub. No.: US 2006/0179013 A1
(43) Pub. Date: Aug. 10, 2006

(54) Configurable distribution of signals in a network

(76) Inventors: Andre Beliveau, Laval (CA); Per Andersson, Montreal (CA)

Correspondence Address: ALEX NICOLAESCU;Ericsson Canada Inc., Patent Department, 8400 Decarie Blvd., Town Mount Royal, H4P 2N2, CA

(21) Appl. No.: 11/261,483

(22) Filed: Oct. 31, 2005

Related U.S. Application Data
(60) Provisional application No. 60/651,221, filed on Feb. 10, 2005.

(51) Int. Cl. G06G 7/00; G06F 15/18

(52) U.S. Cl. 706/6

(57) ABSTRACT

A method and a distributor are provided for ensuring efficient and expandable distribution of signals in a network. Distribution rules are defined by configuration in a distributor. A rule comprises one or more patterns used to attempt finding a match with a signal content. A result of a match attempt in a rule may lead to a destination for the signal content or to another rule. Rules are assembled hierarchically to form a decision tree. A network of distributors may be used instead of a single distributor. Functional units use distributors to exchange signals content. A configuration of the decision tree can be modified without impacting ongoing signal distribution. Functional units can be added, split or otherwise reorganized without having to cater for signal distribution modifications.

### PRIORITY STATEMENT UNDER 35 U.S.C. S.119(e) & 37 C.F.R. S.1.78

This non-provisional patent application claims priority based upon the prior U.S. provisional patent application entitled “Configurable Distribution Of Signaling In A Network”, application No. 60/651,221, filed Feb. 10, 2005, in the name of André Béliveau and Per Andersson.

### BACKGROUND OF THE INVENTION

1. Field of the Invention

The present invention relates to a method and a distributor for distribution of signals in a network.

2. Description of the Related Art

Exchange of information in a network is a complex problem. Today's existing networks oftentimes comprise hundreds or even thousands of interrelated nodes. A node generally comprises a function, or a feature, comprised within a “functional unit”, the functional unit representing the essence of the node. Otherwise stated the functional unit represents the motivation for using the node. Functional units as described here encompass a very wide range of features, for example a database, a telecom node, a server or a client. The node implementing its feature within a functional unit also generally comprise extensive software, hardware, configuration information, or combination thereof, in order to enable communication with other nodes.

A traditional database application may be implemented in a single database application node comprising a first functional unit and a second functional unit, the first functional unit further comprising a file server feature, the second functional unit further comprising a database feature. The database application node also must comprise a built-in manner to communicate with clients of the database application. The manner in which the database application node communicates with clients is generally implemented by custom design, specific to this application. In order to extend the capacity of the database application, such database application node may be split into two new nodes, comprising a first node serving as a file server and a second node serving as a database. In a prior art system comprising the file server node and the database node, each of these two new nodes must be implemented with sufficient information to be able to communicate with each other, in addition to the already provided manner used to communicate with clients. Otherwise stated, a sender of a signal must know a large amount of configuration information of a receiver for said signal in order to properly address the signal. Hence, splitting of a node for database application into two specialized nodes implies large amounts of new development, added configuration work and added processing in each resulting specialized nodes. Adding still further file server nodes and database nodes to the database application, in an effort to add capacity and redundancy, again implies more development related to the need to exchange information between nodes. Likewise, addition of nodes requires more configuration and processing in each file server node and in each database node. Addition of more nodes in such database application provides diminishing returns as each addition of a new node forces the other nodes to work harder at processing configuration data required to communicate with the new node.

As the needs of the network evolve, many improvements may desirably be added to its nodes to enhance their capabilities. Examples of new and improved features that may not initially be designed in functional units comprise a load regulator, a filter, and a firewall. Another example comprises a copy feature for messages between the functional units wherein message copies may be used for multicasting of information or for sending information to added destinations such as to law enforcement agencies or to statistical databases. Persons of ordinary skills in the art will know that many more examples of enhanced features can be added to the functional units. They will also expect that every new addition of features in a prior art application network greatly impacts the design and possibly the capabilities of the functional units and of the nodes. In the prior art, such redesign of the nodes normally alters their inherent features, or the manner in which nodes communicate, or both. A processing speed and capacity of the nodes in a prior art application network may also be negatively impacted by the addition of new features. For example, major redesign of a node is normally expected, at significant cost, to add to the node a multicasting feature that would impact both the features of its functional units and communication processes of the node.

FIG. 1 shows an exemplary prior art Code Division Multiple Access (CDMA) 2000 network 100 comprising a Mobile Switching Center (MSC) 110, two Base Station systems (BS 120 and BS 130), each BS comprising a Base Station Controller (BSC 122 and BSC 132) and several Radio Base Stations (RBS 124 and RBS 134), a Packet Core Function (PCF) 140, a Packet Data Service Node (PDSN) 150 and a Home Location Register (HLR) 160. Those familiar with mobile communication networks in general and with CDMA 2000 networks more specifically will appreciate that a typical network generally comprises a larger number of MSCs, BSs, PCFs, PDSNs and HLRs. Those familiar with telecommunication networks and datacommunication networks will appreciate that interfaces between elements of FIG. 1 may either be direct or indirect. In a direct connection, a physical connection links two nodes. In an indirect connection, two nodes communicate through a distinct transport network (not shown). The MSC 110 provides mobile communication services such as call control, services and mobility management for mobile terminals currently located within a coverage area of the BSC 122 or within a coverage area of the BSC 132. Users of the mobile terminals have their subscription data in the HLR 160. Communication between the MSC 110 and the HLR 160 is made by use of TIA-41 interface 170, specified in the TIA/EIA-41 standard of the Telecommunications Industry Association (TIA), while communication between the MSC 110 and the BSCs 122, 132 is made by use of A1/A2/A5 interface 180 as defined in the Inter-Operability Specification (IOS) for CDMA 2000 Access Network Interfaces of the Telecommunications Industry Association, hereinafter named “IOS”. IOS also specifies an A3/A7 interface 182, an A8/A9 interface 183 and an A10/A11 interface 184.

In order for the MSC 110 of FIG. 1 to send a message towards the BSC 122 by use of the A11A2/A5 interface 180, the MSC 110 uses configuration data (not shown) of that receiving BSC 122, such as list of cells of that BSC 122. Such configuration data is required in order to distinguish the BSC 122 from the other BSC 132 directly related to the MSC 110. In order for the MSC 110 to send a message towards the HLR 160, the MSC must analyze configuration data (not shown), comprising a number analysis of a mobile terminal identity, in order to identify a specific receiving HLR holding a subscription for a mobile subscriber of interest. Those of ordinary skills in the art know that, in reality, a CDMA 2000 network comprises a multiplicity of HLRs. Hence, it is required that the MSC 110 identifies a specific HLR prior to sending a message towards the specific HLR holding a subscription for the mobile subscriber of interest. Likewise, it may be necessary for the BSC 122 and the BSC 132 to exchange information by use of the A3/A7 interface 182. For example, when a mobile terminal is involved in a call within the coverage area of BSC 132 and when the mobile terminal is moving into the coverage area of BSC 122, setting up an inter-BSC handoff is required. The BSC 132 and the BSC 122 must set up a handoff connection on the A3/A7 interface 182 to continue supporting the call. Hence, both BSCs 122 and 132 must comprise configuration data related to each other's specific coverage areas.

The MSC 110 must comprise a large amount of configurable information in order to be able to communicate with the other elements in the network of FIG. 1. Otherwise stated, the MSC 110 must be designed to implement (i) the call control, services and mobility management features that constitute its essential functions, or functional unit, and (ii) a mechanism to enable communication towards receivers of signals generated from the MSC 110. In general, the communication mechanism between network elements, or functional elements, such as the HLR 160, the MSC 110, the PDSN 150, the PCF 140 and the BSCs 122 and 132 of FIG. 1, is selected very early in a design stage. This leads to solutions that are oftentimes restrictive in their usage. As the number of receiving nodes in a network increases, early design decisions may limit the possibilities for expansion. For example, important redesign of the MSC 110 may be required when the number of corresponding HLRs increases beyond a limit set in early design. Likewise, a change of transport layer between nodes, such as a change from Signaling System number 7 (SS7) to Internet Protocol (IP), implies a large redesign of the communication mechanism built in the nodes.

In the case of telephony equipment such as telephony switches, mobile switching centers such as the MSC 110 of FIG. 1, long distance carrier exchanges and the like, an important aspect of the communication mechanism is a number analysis of a telephone number also comprising, in the case of mobile telephony, a number analysis of a mobile station identity. When making a phone call, a caller dials a number of a party he/she intends to reach. In old mechanical switches, each digit of a dialed party number was processed individually, in sequence. Modern electronic switches replicate this mechanism by analyzing in software each dialed number and passing each number, in sequence, in a number analysis table. The number analysis table consists of additional information that can be attached to a phone call such as tags, comprising for example billing information and ring type, and routing information indicating where the phone call shall continue. For example, in a North American local telephone exchange, whenever the caller dials a number starting with “1”, the phone call is routed from the local telephone exchange to a long distance carrier exchange otherwise known as transit switch. The number analysis table of the local telephone exchange is configured so that whenever “1” is a first digit of a dialed number, the number analysis is immediately ended and the phone call is sent to an outgoing trunk connected to the long distance carrier exchange. The number analysis table can be enhanced to be able to route calls to logical functions such as, for example, call blocking, call transfer or routing to a voice mail service. Those familiar with telephony functions in general already know that such number analysis is a very complex element of modern telephony equipment.

In Internet, nodes communicate with each other by use of IP addresses. When a client sends a query towards a server, it builds a data packet, also called datagram, comprising a destination IP address of the server, a payload built according to the nature of the query, the datagram also comprising many more elements known to those of ordinary skills in the art such as the client's own IP address, IP protocol information, other layer protocols such as, for example, a Transaction Control Protocol (TCP) header or an User Datagram Protocol (UDP) header. The client sends the datagram to a router. The router attempts to find a match between the destination IP address of the server, found in a well-known position within the datagram, and various IP address classes, also well-known in the art. A process of matching the destination IP address and the IP address classes enable the router to forward the datagram, either directly to the server or to a further router wherein the process, called routing, is repeated until the server is reached. When the server receives the query, if its internal processing allows a favorable response to the query, it builds a new datagram comprising the client's IP address as a new destination IP address, a response to the query as a new payload, and other well-known elements of a datagram. The server sends the new datagram to a router to initiate a new routing process essentially identical to the routing of the initial query. Hence, the IP routing process relies fully on a table of well-known IP address classes and on a well-known position of the destination IP address within a well-known datagram structure.

At first glance, routing of messages by use of IP addresses provides a simple and effective method to enable communication between two or more nodes. IP address routing however suffers from many deficiencies, two of which are addressed here. First, the originator of a datagram may not know the IP address of the destination node, for instance the IP address of the aforementioned server; a solution to this first deficiency is the use of other network nodes, such as Dynamic Host Configuration Protocol (DHCP) nodes, not inherently present in the CDMA 2000 network of FIG. 1. Second, an existing network such as the CDMA 2000 network 100 of FIG. 1 may not be designed to use IP addressing at all. The CDMA 2000 network 100 typically uses an SS7 protocol. Modifying the MSC 110, BSCs 122 and 132, HLR 160 and other nodes of the CDMA 2000 network 100 to use an IP protocol and addressing represents a major task, not the least of which being compatibility problems between nodes of the CDMA 2000 network 100 that are modified first and other nodes of the same network that are still unmodified. As with any other change to the manner in which nodes communicate in the CDMA 2000 network 100 of FIG. 1, such a modification would greatly impact any mobile subscriber traffic supported by the network at the time of the modification.

There would be clear advantages of having a method and a network node for distributing signals between functional elements of any type without having to design any first functional element with specifics from any other functional element or with specifics of any communication mechanism. Such a method and network node for signal distribution would not be limited to distribution based on a single type of signals protocol, but rather would have the capability to adapt to any type of signals. The signal distribution should be changeable at any time, without affecting functional elements and without negatively impacting any ongoing traffic.

### SUMMARY OF THE INVENTION

It is therefore a broad object of this invention to provide a method and a distributor for distributing signals between functional elements in a network in a manner that enables sending functional elements to be designed and configured independently from configuration information related to receivers of such signals.

A first aspect of the present invention is directed to a method for signal distribution, comprising the steps of receiving at a distributor a string of bytes, applying a rule at said distributor, said rule comprising a matching step for finding a match between any part of said string of bytes and a pattern of bits, said rule further comprising at least two results. If a result of said rule is a further rule, the further rule is applied. If a result of said rule is a destination, the string of bytes is sent towards said destination. A pattern of bits and two or more results of a matching between the string of bytes and the pattern of bits form a rule. Because the result of the matching step as per a rule may be a further rule, the rules are linked in a manner that form branches of a decision tree.

A second aspect of the present invention is directed to a distributor, comprising an entry point for receiving a string of bytes from an origin, an output for forwarding said string of bytes towards a destination, a decision tree comprising at least one rule, said rule further comprising a pattern of bits and at least two results, a processor for effectuating a pattern matching between any part of said string of bytes and said pattern of bits and for deciding on a result. At least two results are possible based on an outcome of the matching: a result may either be a further rule or the destination where the string of bytes is to be forwarded. Because the result of a rule may be a further rule, said rules are linked to one another to form branches of a decision tree.

A third aspect of the present invention is directed to a distribution network comprising two or more distributors. Each distributor comprises a decision tree further comprising rules for pattern matching between any part of a string of bytes and a pattern of bits defined in each rule. A result of a rule in a distributor may designate another distributor as a destination. Two or more distributors are linked by a hierarchy of rules in their decision trees.

### BRIEF DESCRIPTION OF THE DRAWINGS

For a more detailed understanding of the invention, for further objects and advantages thereof, reference can now be made to the following description, taken in conjunction with the accompanying drawings, in which:

FIG. 1 (Prior Art) shows an exemplary CDMA 2000 network;

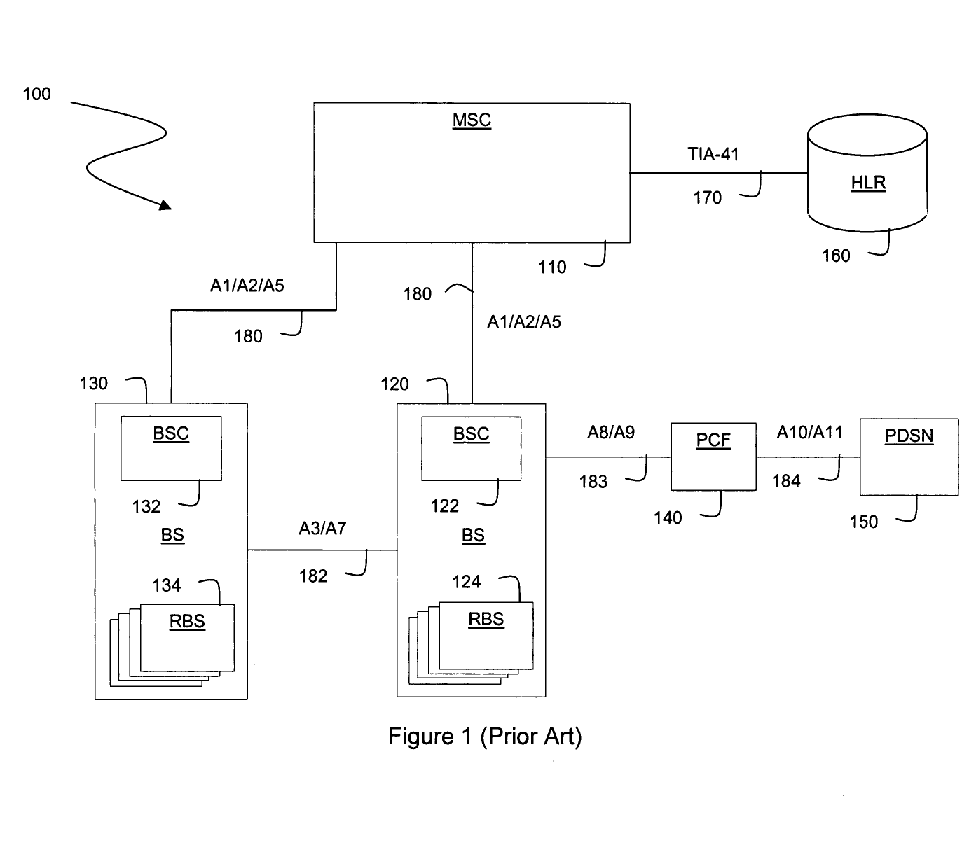

FIG. 2 shows a schematic diagram of a distributor;

FIG. 3a shows parts of a mobile communication network modified in accordance with some aspects of the teachings of the present invention;

FIG. 3b shows a partial content of a RegistrationNotification message for use by the mobile communication network of FIG. 3a;

FIG. 3c shows a partial content of a PagingRequest message for use by the mobile communication network of FIG. 3a;

FIG. 3d shows an exemplary representation of details of a decision tree of FIG. 3a;

FIG. 4 shows an exemplary mobile communication network functionally divided in accordance with aspects of the invention;

FIG. 5 shows an exemplary network functionally replicated in accordance with aspects of the invention;

FIG. 6 shows an exemplary network wherein some aspects of the present invention have been incorporated; and

FIG. 7 shows an exemplary application network wherein added features are implemented using a signal distribution method.

### DETAILED DESCRIPTION OF THE PREFERRED EMBODIMENT

The innovative teachings of the present invention will be described with particular reference to various exemplary uses and aspects of the preferred embodiment. However, it should be understood that this embodiment provides only a few examples of the many advantageous uses of the innovative teachings of the invention. In general, statements made in the specification of the present application do not necessarily limit any of the various claimed aspects of the present invention. Moreover, some statements may apply to some inventive features but not to others.

The present invention provides a signal distribution method and a node for efficient and configurable distribution of signals between nodes of a network. A novel node, called a distributor, is introduced. The distributor is configured by an operator and comprises at least one rule. A rule is defined as comprising two parts. A first part of the rule is a pattern of bits, or a range of bit patterns, that may be searched in string of bytes comprising a content, payload, protocol header, or any other type of information found in a signal exchanged between nodes. The second part of the rule comprises at least two possible outcomes of a match between the pattern of bits and the content of the signal. When a node implementing any function or feature, said node herein named “functional unit”, submits to a network information in the form of a string of bytes of any numerical format, said string of bytes being intended to be sent towards a second functional unit, the string of bytes is entered into the distributor. The distributor applies the at least one rule trying to match the pattern of bits of the rule with the content of the string of bytes. Possible outcomes of the match may provide a destination for the string of bytes. Other possible outcomes of the match may consist of a second or more rules. Several rules may be applied to the content of the string of bytes, according to a hierarchy of rules defined by the pattern of bits and the outcomes of each rules. A properly defined set of rules and their hierarchy enable forwarding of the string of bytes towards the proper destination.

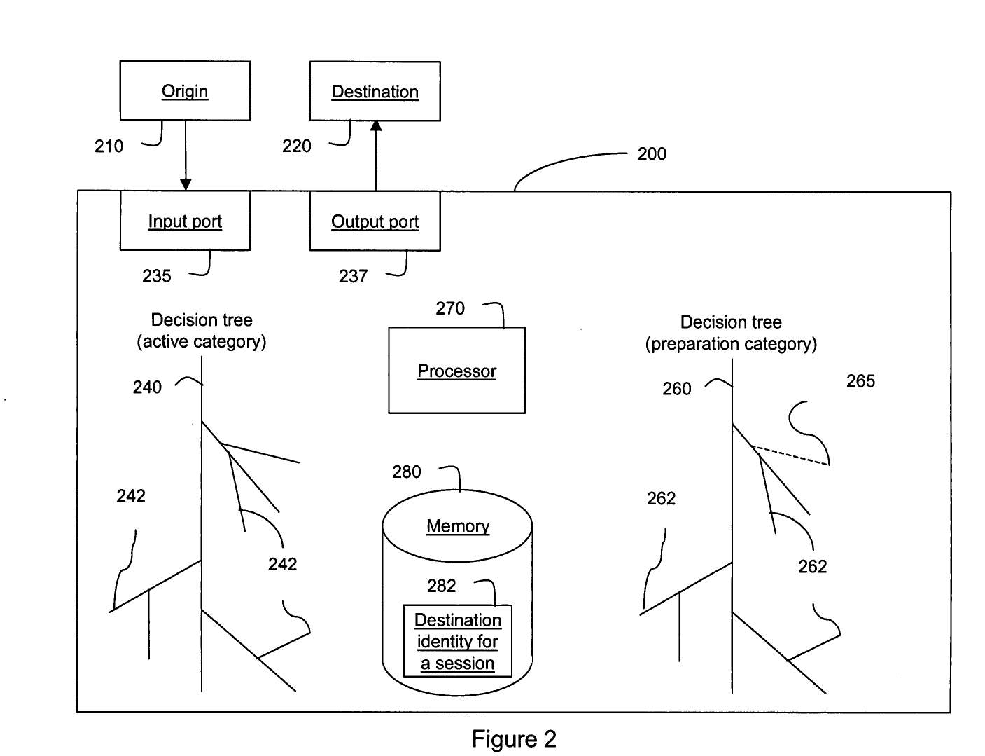

Reference is now made to FIG. 2, which shows a schematic diagram of a distributor 200 interconnected with an origin 210 and a destination 220. Both the origin 210 and the destination 220 may either be functional units or other distributors. The distributor 200 comprises an input port 235, an output port 237, an active decision tree 240 comprising rules 242, a preparation decision tree 260 comprising rule copies 262, a processor 270 and a memory 280. The input port 235 and the output port 237 may support many types of protocols since they may comprise an IP protocol stack or a SS7 protocol stack or support for any other protocol as needed by an application. Likewise, the input port 235 and the output port 237 may be built to support various physical layers, such as for example a cable connection, an Ethernet connection, an optical fiber connection, a copper twisted pair connection, or a radio connection. Communication between the origin 210, the destination 220 and the distributor 200 may be effectuated by use of a direct connection or through any type of transport network. The input port 235 is able to receive and the output port 237 is able to send any numerical format as needed by the application. The numerical format may be a signal, a signaling protocol element, a message, a flow, a packet, an information element, a data, a file, or any string of bytes in general.

A decision tree can be implemented in several manners. One possible aspect of the preferred embodiment is a software program wherein each rule is implemented in a sequential search manner by use of well-known “IF” statements, said “IF” statements being cascaded hierarchically in a manner commonly used in many software programs. Other possible methods to implement a rule or a set of rules comprise for example a table lookup, a table match or a hashing process; such methods may oftentimes be faster than a the sequential search made of cascaded “IF” statements and thus more efficient in converging towards a destination. Among the various types of patterns of bits that can be implemented in the rules of the decision tree, further examples comprise a class of service, a multimedia data format such as for example a JPEG (Joint Photographic Experts Group), a MPEG (Moving Picture Experts Group), a TIFF™ (Tagged Image File Format) or a WAV (WAVerform) format, an Internet Protocol (IP) address, a Uniform Resource Locator (URL), an electronic mail address, a special character set.

The active decision tree 240 comprises at least one rule. The rules in the active decision tree 240 are preferably fully configurable. Alternatively, some distribution rules may be predefined so that the distributor 200 can be put in service immediately upon installation without the need for configuration. When a message, comprising a string of bytes in any format, is received at the input port 235 of the distributor 200, a first rule of the active decision tree 240 is applied to a content of the string of bytes. To apply the first rule, the content of the string of bytes is compared to a pattern of bits defined for said first rule in a pattern of bits matching process of processor 270. The result of said pattern of bits matching of said first rule may be the destination 220, or an input into another rule. Because rules are logically cascaded or linked, they can be visualized as forming a tree-shaped decision engine. When a rule finally provides a destination 220 for the message, the string of bytes that forms said message is sent towards the destination through the output port 237. In one aspect of the preferred embodiment of this invention, the distributor 200 adds information to the string of bytes prior to sending it towards the destination. The added information may provide an indication of a conclusion made by the active decision tree 240. Said added information can be used by the destination. In the case where the destination is a further distributor, a further decision tree may comprise a rule acting on the conclusion made by the active decision tree 240. In a case where the destination is a functional unit, the functional unit may also act upon the added information. For example, the distributor 200 may add information telling the functional unit that the string of bytes is legitimate and safe.

In another aspect of the preferred embodiment, the active decision tree 240 can use session rules. For applications wherein a session comprises consecutive strings of bytes sent by the origin 210 to the destination 220, it may not be optimally efficient to apply a complete set of rules for each subsequent strings of bytes. In this aspect of the preferred embodiment, a session rule may be used to identify a first string of bytes of a new session. When the first string of bytes of the new session is identified, the active decision tree 240 stores in the memory 280 an identity 282 of the destination 220 for all strings of bytes in the new session. When a subsequent string of bytes of an ongoing session is received, the session rule uses the identity 282 of the destination 220 for the ongoing session, previously stored in the memory 280, to forward the subsequent string of bytes to the destination 220.

An operator may wish to modify the rules of the distributor 200 at any time, for example to cater for the introduction of new node elements, such as new functional units and new distributors, or the addition of new services. In many applications such as telecom networks, it is preferable that such modifications shall not impact traffic or service to customers. The distributor 200 may advantageously comprise a preparation decision tree 260 in addition to the active decision tree 240. The active decision tree 240 is used for normal signal distribution. The preparation decision tree 260 is initially identical to the active decision tree 240, in the sense that it comprises a set of rule copies 262 identical to the rules 242 of the active decision tree. The operator may give commands to processor 270 to update the rules copies 262 in the preparation decision tree 260. Such commands may add, delete or modify rules copies 262 in the preparation decision tree 260, as well as changing the links forming interrelations or hierarchy between the rules copies 262. The commands may be entered directly by the operator, with the help of an expert system, or through any operation support system as deemed preferred by the operator. FIG. 2 shows a rule copy being updated 265. The active decision tree 240 may comprise a special test rule for testing the preparation decision tree 260. The test rule comprises a pattern for identification of a test message or test string of bytes. When such pattern is found in the string of bytes, the string of bytes is further analyzed by the preparation decision tree 260 and thus, handled according to the rule copies 262, including the updated copies 265. When the operator is satisfied with the content of the preparation decision tree 260, he/she now has configured a new set of rules. The operator may instruct the processor 270 to commit the changes. By committing the changes, the new set of rules of the preparation category 260 become active and are now applied to any string of bytes arriving at the input port 230. The actual commit process may be implemented by copying the new set of rules from the preparation decision tree 260 into the active decision tree 240. Alternatively, the processor 270 may inform all components of the distributor 200 that the active decision tree 240 and the preparation decision tree 260 are now exchanging their functions. In the latter case, the input port 235 forwards the strings of bytes of new messages to the former preparation decision tree 260, which has now become a new active decision tree.

Those of ordinary skills in the art will understand that the term “node” may apply to any element in a network, whether said element is standalone or co-located with any other element and whether said element has a simple feature set or an extensive feature set. They will also know that the term “network” may apply to any telephony, telecommmunication or datacommunication network. Communication between network elements shown in the drawings, wherein interfaces are illustrated by solid lines between said network elements, may be effectuated over any physical layer, either by a direct connection between said network elements, or indirectly through a separate transport network.

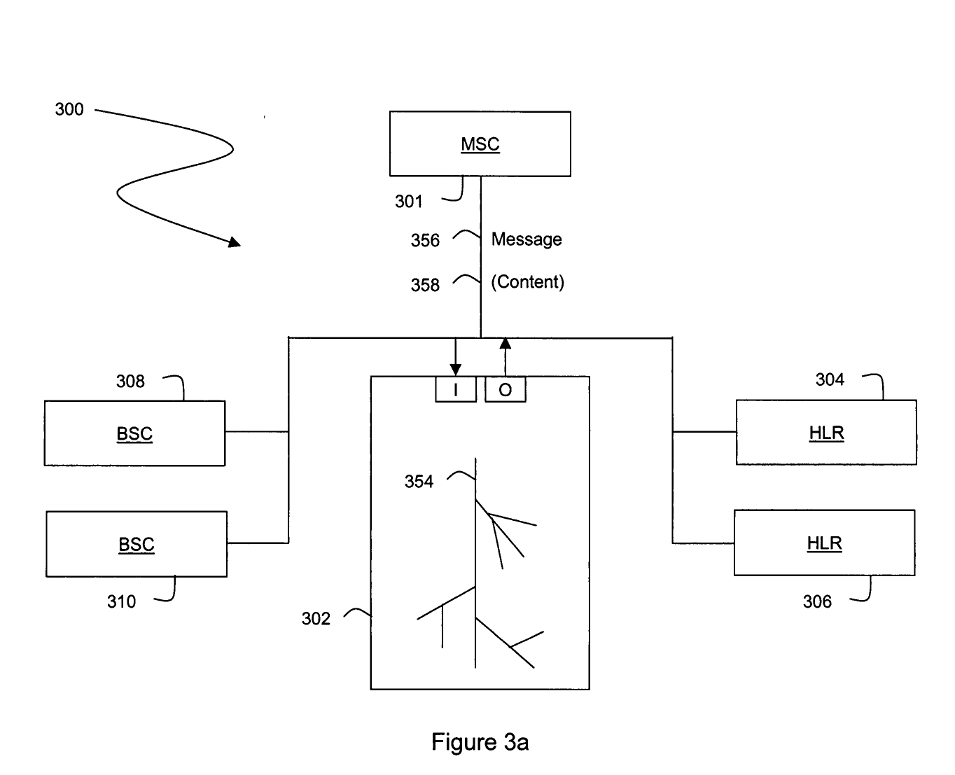

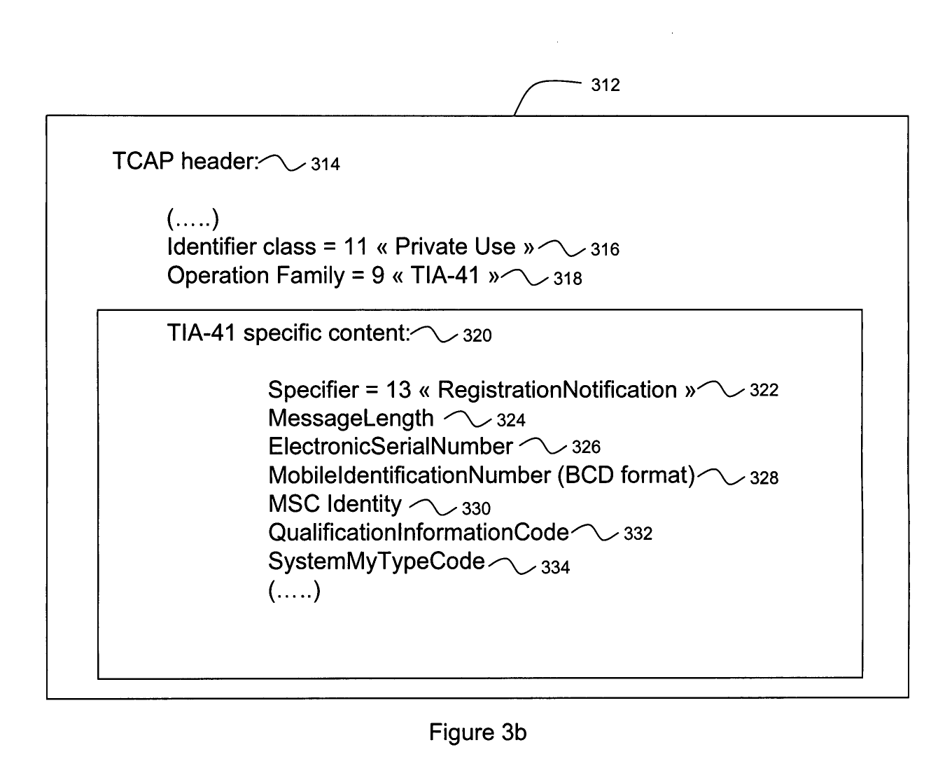

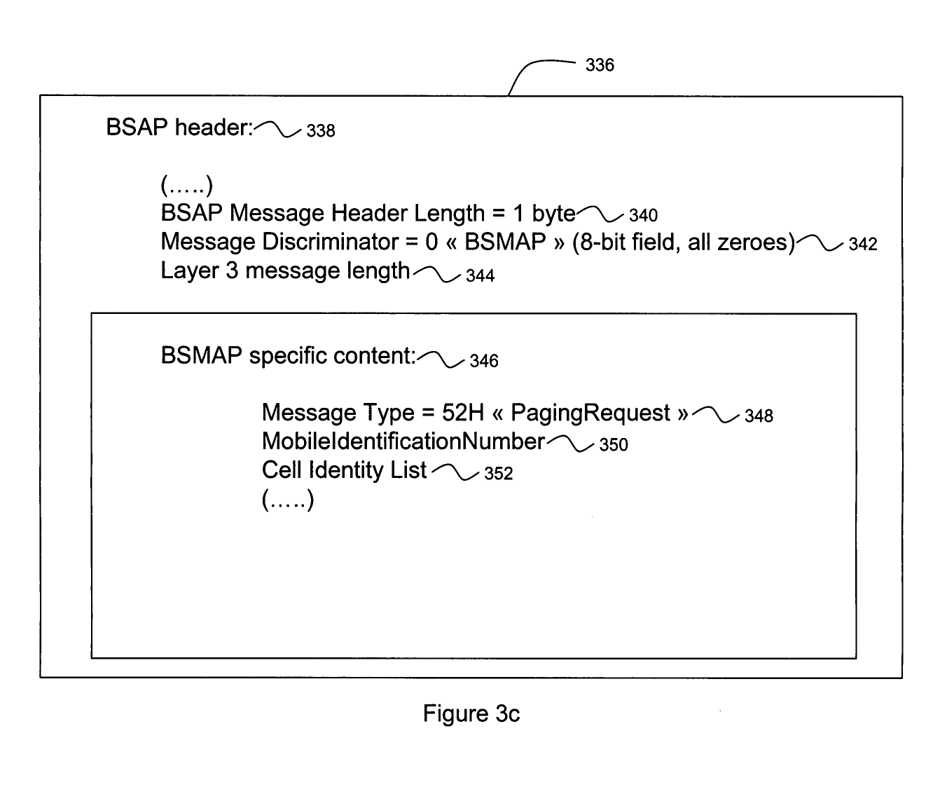

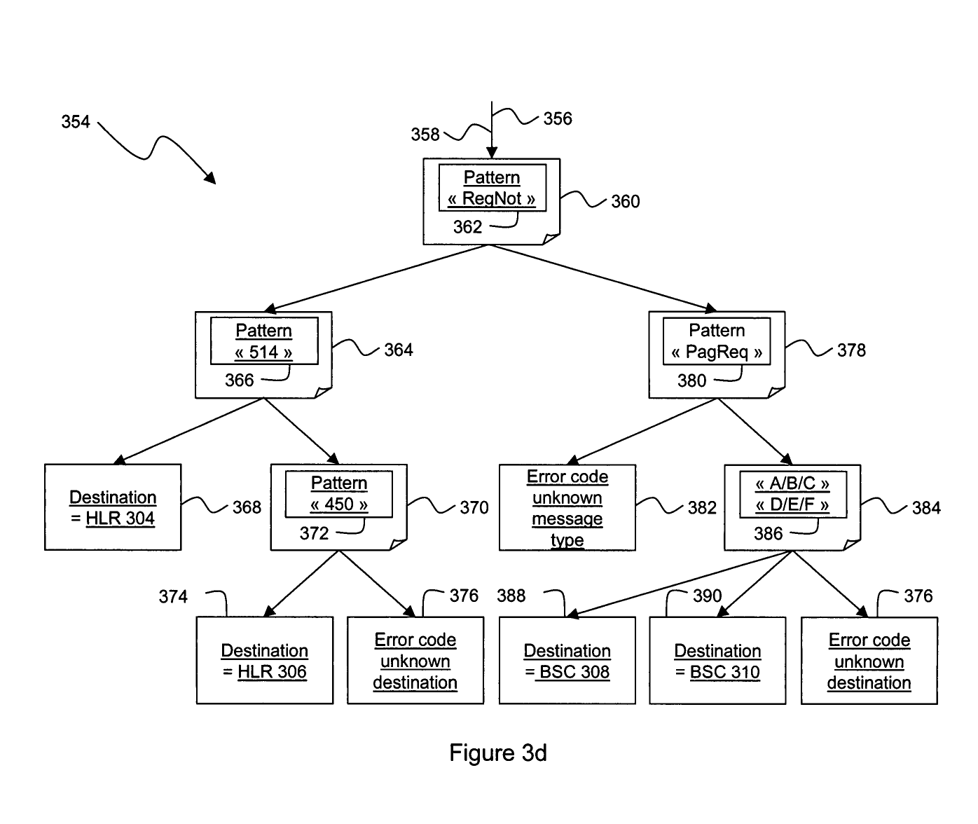

Referring now to FIGS. 3a, 3b, 3c and 3d, an exemplary use of a distributor comprising a decision tree to support a mobile communication network 300 comprising a Mobile Switching Center (MSC) 301 will be described. FIG. 3a shows parts of a mobile communication network modified in accordance with some aspects of the teachings of the present invention, comprising the MSC 301 and a distributor 302, further comprising a decision tree 354, used to ensure signal distribution for the MSC 301, a first Home Location Register (HLR) 304 and a second HLR 306, a first Base Station Controller (BSC) 308 and a second BSC 310. Each of the MSC 301, the HLR 304, the HLR 306, the BSC 308 and the BSC 310 are telecom nodes comprising telecom processes with sets of features to support mobile telecommunications. These telecom nodes are functional units. FIG. 3b shows a partial content of a RegistrationNotification message 312 for use by the mobile communication network of FIG. 3a, as defined by the Telecommunications Industry Association (TIA), wherein a TIA-41 specific content 320 is encapsulated within an American National Standard Institute (ANSI) T1.114 Transaction CAPability (TCAP) format also comprising a TCAP header 314. For simplicity, many parameters not relevant to this exemplary use of the distributor are not shown in FIG. 3b. FIG. 3c shows a partial content of a PagingRequest message 336 for use by the mobile communication network of FIG. 3a, as defined in an Inter-Operability Specification (IOS) protocol, wherein a Base Station Management Application Part (BSMAP) specific content 346 is encapsulated within a Base Station Application Part (BSAP) format comprising a BSAP header 338; for simplicity, many parameters not relevant to this exemplary use of the distributor are not shown in FIG. 3c. Finally, FIG. 3d shows an exemplary representation of details of the decision tree 354 of FIG. 3a. The decision tree 354 of FIGS. 3a and 3d is of a same nature and has a same purpose as the active decision tree 240 of FIG. 2. The decision tree 354 comprises rules 360, 364, 370, 378 and 384 linked in a hierarchical manner, each rule comprising one or more patterns of bits for pattern matching with a content 358 of a message 356, each rule also comprising a minimum of two (2) possible outcomes. The rules 360, 364, 370, 378 and 384 are configurable and are generally defined by an operator, though other means such as for example an expert system or an operation support system can also provide a configuration to the distributor 302. The rules 360, 364, 370, 378 and 384 are linked to from the decision tree 354.

The MSC 301 of FIG. 3a may form a RegistrationNotification 312, illustrated in details on FIG. 3b, intended to be sent towards the HLR 304 or to the HLR 306. The purpose of the RegistrationNotication 312 is to inform the HLR 304 or the HLR 306 of the active presence of a mobile subscriber within a coverage area of the BSC 308 or within a coverage area of the BSC 310, both BSCs being connected to the MSC 301. The RegistrationNotification 312 also requests a profile of the mobile subscriber from the HLR 304 or from the HLR 306. The RegistrationNotification 312 is defined in the TIA-41 standard. Alternatively, the MSC 301 may form a PagingRequest 336, illustrated in details on FIG. 3c, intended to be sent towards the BSC 308 or to the BSC 310. The purpose of the PagingRequest 336 is to terminate a call to the mobile subscriber, said mobile subscriber being known to be active within the coverage area of the BSC 308 or within the coverage area of the BSC 310. The PagingRequest 336 is defined in the IOS standard. In the simplified example of FIG. 3a, the first HLR 304 supports subscribers whose area code number is 514 and the second HLR 306 supports subscribers whose area code number is 450; the first BSC 308 supports cells A, B, C and the second BSC 310 supports cells D, E and F. For a simplified illustration of this exemplary use of the present invention, the MSC 301 is only capable of sending the two aforementioned messages, that is the RegistrationNotification 312 and the PagingRequest 336. Those of ordinary skills in the art know that a MSC is normally capable of sending many more messages to HLRs and to BSCs, as well as sending other messages to other MSCs and to other nodes not mentioned herein.

Per some of the teachings of the present invention, the MSC 301 sends the message 356 comprising the content 358 in the form of a series of bytes, or string of bytes, to the distributor 302. The distributor 302 of FIG. 3a comprises a decision tree 354, which has been configured by an operator for use with the MSC 301, said configuration being specifically for the purpose of receiving RegistrationNotification 312 and PagingRequest 336 messages. The decision tree 354 applies a first rule 360, configured by the operator to attempt to match the content 358 of the message 356 with a RegistrationNotification pattern of bits 362 comprising an Identifier Class 316 equal to eleven (11), an Operation Family 318 equal to nine (9) and a Specifier 322 equal to thirteen (13). If a match is found in the first rule 360, it is found that message 356 actually is the RegistrationNotification 312. Those familiar with the TIA-41 standard and with underlying lower physical and transport layers will recognize that a larger number of content items of message 356 actually need to be matched with an even number of patterns of bits, within one or more rules, in order to identify the RegistrationNotification 312. The example shown herein is simplified for illustration purposes. It is to be understood that the distributor 302 of FIG. 3a is configured as per the needs of the mobile communication network 300. Thus, the configuration of the present distributor 302 is only required to enable identification of messages that pertain to the needs of the mobile communication network 300. As a RegistrationNotification pattern of bits 362 was found by applying the first rule 360, a second rule 364 is applied to find a match between the content 358 of the message 356 and an first area code pattern of bits 366 equal to a Binary Coded Digital (BCD) representation of “514”. If a match is found in the second rule 364, a destination 368 for message 356 has been found, a receiving functional unit consisting of the HLR 304, said HLR 304 holding all subscriptions for mobile subscriber having an area code number “514”. If no match is found in the second rule 364, a third rule 370 is applied to find a match between the content 358 of the message 356 and a second area code pattern of bits 372 equal to a BCD representation of “450”. If a match is found in the third rule 370, a destination 374 for message 356 consists of the HLR 306, said HLR 306 holding all subscriptions for mobile subscriber having an area code number “450”. If no match is found in the third rule 370, the MSC 310 is attempting to send the RegistrationNotification 312 towards an unreachable destination. An error code 376 indicating that the message is undeliverable due to an unreachable destination is added to the message 356, which is sent back to the MSC 301. Returning now to the first rule 360, if no match is found between the content 358 of the message 356 and a RegistrationNotification pattern of bits 362, a fourth rule 378 is applied to find a match between the content 358 of the message 356 and an PagingRequest pattern of bits 380 comprising a BSAP Message Header Length 340 equal to one (1) byte, a Message Discriminator 342 equal to zero (0), and a Message Type 348 equal to 52 H. If no match is found in the fourth rule 378, an error code 382 indicating that the message 356 is of an unknown type is added to the message 356, which is returned to the MSC 301. If a match is found in the fourth rule 378, a fifth rule 384 is applied to find a match between the content 358 of the message 356 a table of cell identities 386, said table comprising a pattern for each cell identity. A match to cell A, B or C indicates that a destination 388 is a receiving functional unit consisting of the first BSC 308. A match to cell D, E or F indicates that a destination 390 is the second BSC 310. In the absence of a cell identity match in the fifth rule 384, the message 356 is deemed to be undeliverable. The error code 376 indicating that the message is undeliverable due to an unreachable destination is added to the message 356, which is returned to the MSC 301.

A distributor as described hereinbefore may be substituted by a network of distributors. In an alternate aspect of the invention, a functional unit sends a string of bytes to a distribution network. A first distributor in the distribution network applies a number of rules leading to forwarding the string of bytes to a further distributor, possibly adding information related to a conclusion of an analysis based on rules of a decision tree of the first distributor. The further distributor then applies another set of rules, said rules possibly configured to use the conclusion added by the first distributor, and the process continues until the string of bytes is actually delivered to an intended functional unit, as appropriate. For example, the distributor 302 of FIGS. 3a and 3d can be replaced by a distribution network comprising three distributors. In the distribution network, a first distributor comprises a set of rules having three possible outcome. If a first outcome is that the message 356 is the RegistrationNotification 312, a destination is a second distributor for further processing of the RegistrationNotification 312. If a second outcome is that the message 356 is the PagingRequest 336, another destination is a third distributor for further processing of the PagingRequest 336. If a third outcome is that the message 356 is not identified, the error code 382 indicating that the message 356 is of an unknown type is added to the message 356, which is returned to the MSC 301. The manner in which rules are implemented is essentially similar in any distributor built according to the teachings of the present invention, but the rules of each distributor are specifically defined according to the needs to the nodes in direct correspondence with said each distributor. Otherwise stated, a hierarchy of rules in decision trees of the distributors is defined by the operator in a manner that enables forwarding of a string of bytes towards the intended functional unit. The number of distributors in the distribution network and the size of each distributor is a matter of capacity, processing speed, reliability and other characteristics. In the distribution network, the distributors may each comprise an active decision tree and a preparation decision tree for enabling an operator to define modifications to rules of the preparation decision trees. Committing changes can advantageously be effectuated simultaneously in all distributors of the distribution network. Committing changes in this simultaneous manner ensures that rules are consistent throughout the distribution network at all times.

A first distributor used to receive all messages coming from a functional unit is a neighbor distributor for said functional unit. The distributor 302 of FIG. 3a is therefore a neighbor distributor as seen from the MSC 301. The distributor 302 could at the same time act as a neighbor distributor for other nodes, such as for example the HLRs 304 and 306, and the BSCs 308 and 310. Because the neighbor distributor of FIG. 3a makes necessary determinations of the destination for messages coming from the MSC, said MSC does not need to comprise any configuration data normally used in the prior art to designate an HLR or a BSC as a recipient of a message. As a result, a new MSC can be advantageously designed without having to cater for communication with predefined numbers of HLRs, neighbor MSCs, or BSCs. The new MSC can thus be designed to only comprise a functional unit, mainly comprising call control, services and mobility management features. The only communication means required in the new MSC is a capability to send messages, or strings of bytes, to its neighbor distributor. Such a minimal communication capability only requires trivial design work. Alternatively, if distributors built according to the teachings of the present invention are added to an existing network, no redesign of the existing nodes is required. In the case of an existing, prior art MSC comprising a number analysis table previously used as a part of a communication means to determine an HLR as a recipient for TIA-41 messages, a content of said table can simply be deleted or otherwise inactivated and replaced with an identity of a neighbor distributor for that MSC for receiving any and all TIA-41 messages. As a result, a design of the existing MSC does not need to be modified in order to be able to use a distributor. As the mobile communication network 300 evolves, for instance by addition of a very large number of new HLRs, the MSC does not need to be updated. Hence, there is still ample benefit in using a distributor to support a prior art MSC having been designed to comprise a functional unit as well as its own communication mechanism.

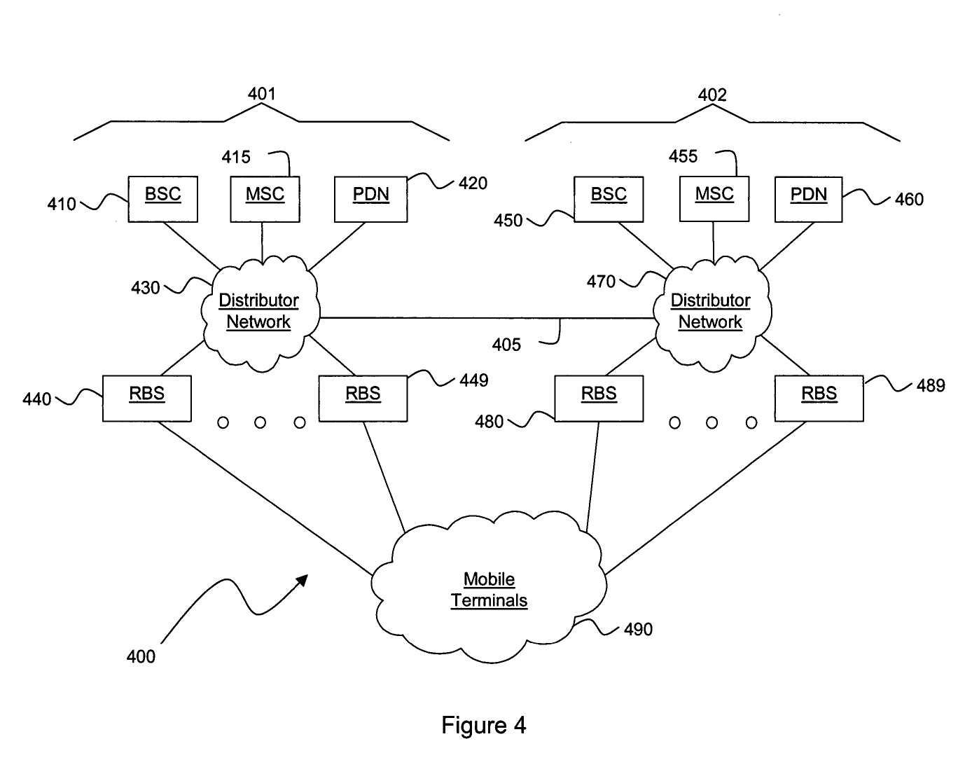

Reference is now made to FIG. 4, which shows an exemplary mobile communication network 400 functionally divided in accordance with aspects of the invention. Application partitioning is implemented by a method of functional division. The mobile communication network 400 comprises two subnetworks 401 and 402, each comprising a BSC 410 and 450, a MSC 415 and 455, a Packet Data Node (PDN) 420 and 460. The PDNs are used in the mobile communication network 400 to provide services similar to those of the MSC, specifically for packet data connections. Each subnetwork also comprise a distribution network 430 and 470 and Radio Base Stations (RBS) 440-449 and 480-489. An interface 405 is provided between the networks of distributors 430 and 470. The mobile communication network 400 further comprises a number of mobile terminals 490.

The mobile communication network 400 is a functionally divided network. An operator of mobile communication network 400 may initially have built said network by installing one BSC 410, one MSC 415 and one PDN 420, along with RBSs 440-449, without partitioning the network into subnetworks. As the needs and the number of users of mobile terminals 490 increases, the operator has an option of replacing the single BSC 410, MSC 415 and PDN 420 with larger, more powerful and more expensive nodes of a same nature to support new RBSs 480-489 and a larger number of mobile terminals 490. The operator may rather take advantage of the signal distribution method and distributors of the present invention. The BSC 410, MSC 415 and PDN 420, as well as RBSs 440-449 and the distribution network 430 already in use are to be construed as a subnetwork 401. The second BSC 450, MSC 455 and PDN 460, the new RBSs 480-489 and the distribution network 470 are then installed, forming the new subnetwork 402. As shown on FIG. 4, the two similar subnetworks 401 and 402 each comprise similar elements wherein telecommunication functions of the BSCs, MSCs and PDNs remain functionally divided in distinct functional units. In the prior art, it would have been necessary, in order to provide for inter-BSC handoff functionality, to add configuration data in the two BSCs 410 and 450 about each other's coverage area. Such a task would become more complex as additional BSCs would be added to the mobile communication network 400. According to the present aspect of the invention, any necessary configuration information to support inter-BSC handoff is instead implemented in distributors of the distribution networks 430 and 470. Rules in distributors of the distribution networks 430 and 470 enable the use of the interface 405 for carrying inter-BSC signaling and payload. Functional division is ideally suited in general to telecommunication networks wherein each functional unit in a subnetwork is dissimilar. For example the BSCs, the MSCs and the PDNs of FIG. 4 are highly specialized and complex dissimilar nodes.

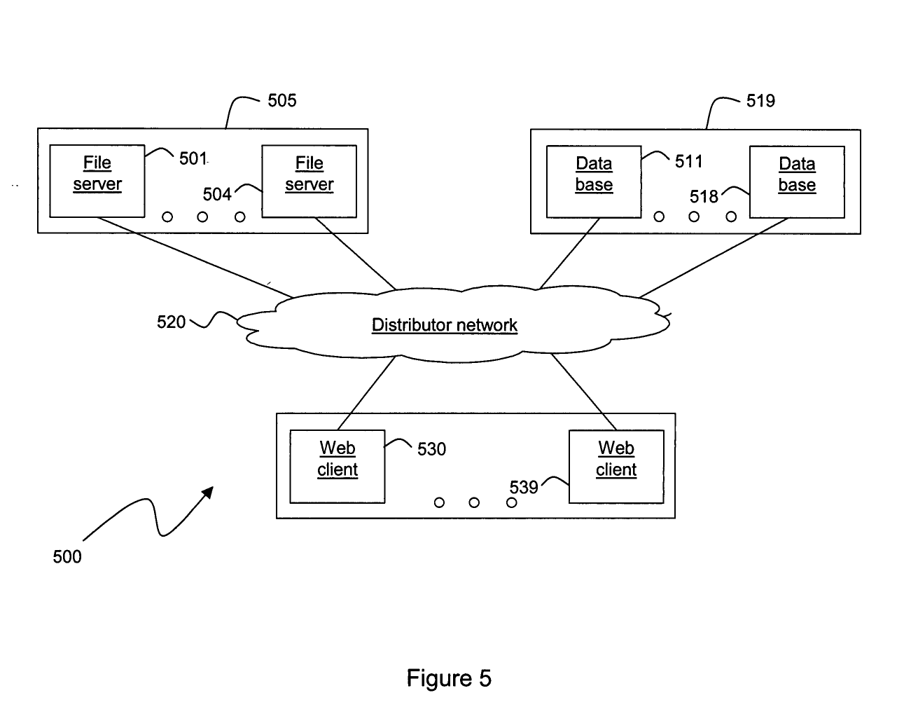

Referring now to FIG. 5, an exemplary network functionally replicated in accordance with aspects of the invention is shown. While FIG. 4 shows an example of application partitioning by functional division, functional replication is used in FIG. 5 wherein load balancing and redundancy between various functional units is desired. FIG. 5 shows a database application 500 wherein a first multiplicity of functional units, acting as file servers 501-504, enable access to a second multiplicity of other functional units, acting as databases 511-518, to many other functional units, acting as web clients 530-539. A number of distributors built according to the preferred embodiment of the present invention form a distribution network 520.

The database application 500 of FIG. 5 is functionally replicated. File servers 501-504 are essentially identical and, together, form a first functional unit group. This first functional unit group acts as a virtual file server 505 wherein the file server functional units are replicated. The number of actual file servers within the virtual file server 505 is selected so there is sufficient capacity to serve a desired number of database access requests while providing some redundancy in case of failure of some of the file servers 501-504. Likewise, databases 501-518 are essentially identical and, together, form a virtual database 519 wherein the database functional units are replicated within a second functional unit group. The first functional unit group and the second functional unit group are dissimilar because their functional units comprise distinct features and uses. The number of actual databases within the virtual database 519 is selected so there is sufficient capacity to serve a desired number of database access requests while providing some redundancy in case of failure of some of the databases 511-518.

The distribution network 520 comprise rules specifically defined by an operator to support the functional replication of the database application 500. For example, some of the rules ensure that database access requests from web clients 530-539 are dispatched to file servers 501-504 in a manner, such as for example round robin, that ensures an even load distribution within the first functional unit group. Rules are also used to automatically redistribute load on operative file servers 501-503 in an event that file server 504 is out of service or experiencing any problem preventing it from fulfilling its role in a normal way. In a same manner, if the file server 502 determines that a database access request received from one of the web clients 530-539 is valid and information may be fetched from a database, the distribution network 520 receives an indication from the file server 502 and forwards the database access request to one of the databases 511-518, for example by use of rules that ensure an even load distribution on said databases while also ensuring an automatic redistribution of load on valid databases in the event that one of the databases 511-518 is taken out of service.

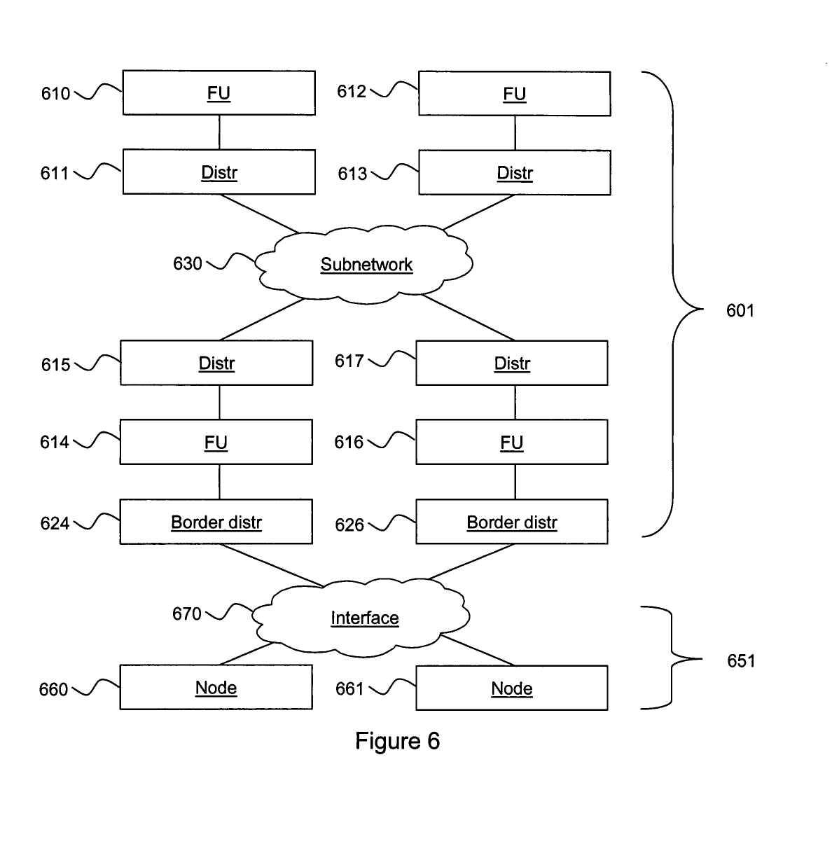

Reference is now made to FIG. 6 which shows an exemplary network wherein some aspects of the present invention have been incorporated. FIG. 6 shows an adapted network 601, which is implemented using the teachings of the present invention, and a non-adapted network 651 which uses a prior art method of communication. The adapted network comprises several functional units 610, 612, 614 and 616, several distributors 611, 613, 615, 617, two border distributors 624 and 626, and other communication means shown as subnetwork 630. Subnetwork 630 may comprise any interface according to any IP, ATM or SS7 protocols or other protocols. Subnetwork 630 may comprise ATM switches, routers or other telecom switches. Subnetwork 630 may also comprise further distributors using the method of the present invention. The distributors 611, 613, 615 and 617 are neighbor distributors to the functional units 610, 612, 614 and 616, respectively. Said distributors 611, 613, 615 and 617 comprise the necessary sets of rules to communicate with functional units and other distributors through the subnetwork 630, according to any structure of subnetwork 630. Each of the functional units 610, 612, 614 or 616 and its respective distributor 611, 613, 615 or 617 may be co-located in a same physical platform or, alternatively, be disjoint.

The non-adapted network 651 of FIG. 6 comprises nodes 660 and 661 that have not been adapted as per the teachings of the present invention. Nodes 660 and 661 are capable of receiving signals or messages from a distributor. But they do not use a distributor for sending messages or signals. Rather, nodes 660 and 661 comprise their own internal communication mechanism. An interface 670 connects nodes 660 and 661 to the border distributors 624 and 626. The border distributors 624 and 626 are distributors according to the hereinabove description, and further comprise rules specifically for communication with nodes that are not adapted to the signal distribution method of the present invention. The border distributors 624 and 626 further hide a structure of the adapted network 601 from non-adapted destinations. Specifics of the functional units within the adapted network 601 are hidden from nodes 660 and 661. For example, the nodes 660 and 661 in the non-adapted network 651 do not need to be aware of a location of any functional unit 610, 612, 614 or 616 in the adapted network 601. The functional unit 610, 612, 614 or 616 may be split into further functional units, either through functional division or through functional replication, without any impact on the nodes 660 and 661 of the non-adapted network 651. By way of a non-limiting example, mobile terminals such as the mobile terminals 490 of FIG. 4, when these are prior art units, are non-adapted nodes in the sense that they are generally not advantageously updated to be able to use the benefits of the signal distribution method provided by distributors. The RBSs of FIG. 4 may then act as border distributors towards the non-adapted network 651, itself comprising prior art mobile terminals. It should however be noted that in a separate example, a mobile terminal can itself be a distributor for a functional unit implemented in an ancillary mobile equipment, such as a portable computer attached to the mobile terminal.

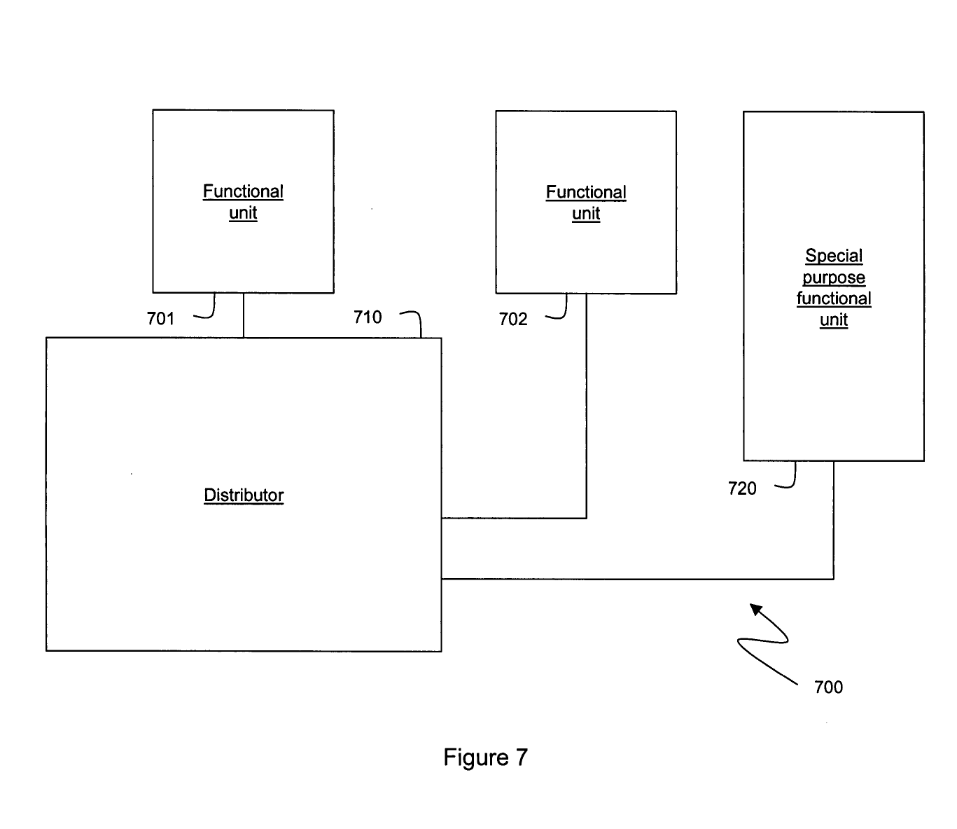

FIG. 7 shows an exemplary application network 700 wherein added features are implemented using a signal distribution method. A first functional unit 701 would communicate, in a prior art situation, with a second functional unit 702, either directly or through some transport network, by use of configuration information internal to the first and second functional units. The first functional unit 701 and the second functional unit 702 may be, by way of non-limiting examples, an MSC and an HLR, a first MSC and a second MSC, a client and a server, a bank server and an automatic teller machine, or a web browser and a web server. Communication between the first functional unit 701 and the second function unit 702 is effectuated, in a prior art network, by use of an IP network, an SS7 network, or other types of networks as appropriate to an application, in a manner that is well known in the art. In an aspect of the preferred embodiment of the present invention, a distributor 710 is used to forward messages between the first functional unit 701 and the second functional unit 702, in both directions, said two functional units no longer being required to comprise internal configuration information relating to each other functional unit. Incorporation of the distributor 710 into the application network 700 provides the advantages of the present invention. The distributor 710 can be replaced by a distribution network comprising several like distributors; a decision tree (not shown) of the distributor 710 becomes, in this case, a hierarchy of decision trees in the distributors of the distribution network.

In yet another aspect of the preferred embodiment of the present invention, the application network 700 of FIG. 7 comprises a special purpose functional unit 720. To expand the capabilities of the application network 700 by the addition of new features, the special purpose functional unit 720 is added without a need for making complex modifications to the first functional unit 701 or the second functional unit 702. The special purpose functional unit 720 comprises the new features that an operator of network 700 may want to add. Rules in the distributor 710 are modified so that the application network 700 may benefit from the new features of the special purpose functional unit 720. The rules select the special purpose functional unit 720 as the destination of a string of bytes when said string of bytes corresponds to an enhancement provided by the features of the special purpose functional unit 720.

For example, the special purpose functional unit 720 comprises a virus filter capable of detecting harmful viruses that are oftentimes found in today's networks. When the first functional unit 701 sends a message, for example comprising an electronic mail message, intended to be sent to a mail server implemented in the second functional unit 702, distribution rules in the distributor 710 normally identify the second functional unit 702 as a desired destination and the electronic mail message is forwarded accordingly. Because the operator of network 700 has a desire to eliminate viruses, he/she installs a virus filter in the special purpose functional unit 720. The operator also adds or modifies rules in the distributor 710 in order to forward to the special purpose functional unit 720 electronic mail messages intended for the mail server of the second functional unit 702. The rules of the distributor 710 can make all electronic mail messages to be forwarded to the special purpose functional unit 720. Alternatively, the rules can determine that all electronic mail messages comprising an attachment are to be forwarded to the special purpose functional unit 720. The manner in which the rules of the distributor 710 determine a destination for the electronic mail messages is entirely configurable by the operator. When the special purpose functional unit 720 receives the electronic mail message, its virus filter feature analyses the content of the electronic mail message in a conventional manner. If no harmful virus is found, the message is sent back to the distributor 710, possibly with and added indication that the message content is safe. A rule in the distributor 710 then determines that the electronic mail message is safe. This rule may act upon an origin of the message, now being the functional unit 720, or according to said indication of a safe content. The distributor 710 sends the electronic mail message to the second functional unit 702.

In another example, rules in the distributor 710 can be used to forward to the special purpose functional unit 720 all messages intended for the functional unit 702, wherein the special purpose functional unit 720 comprises a load regulator aimed at protecting the second functional unit 702 from overload. The load regulator function of the special purpose functional 702 unit normally forwards such messages to the second functional unit 702, through the distributor 710, but automatically deletes any message when a load limit is exceeded.

In yet another example, the distributor 710 comprises a rule or a set of rules to detect a telephone number for which a law enforcement agency has obtained a court order for monitoring. The rule or rules are used to forward to the special purpose functional unit 720 any message, data, packet, flow, information element, call, or session comprising the telephone number matching a pattem of bits of the rule, said pattern of bits comprising for example the telephone number. A monitoring feature implemented in the special purpose functional unit 720 makes a copy of any string of bytes received from the distributor, originally from the first functional unit 701. The string of bytes is then forwarded normally to the second functional unit 702. The copy of the string of bytes can be recorded within the special purpose functional unit 720, or alternatively forwarded to a further destination (not shown).

Although several aspects of the preferred embodiment of the method and of the distributor of the present invention have been illustrated in the accompanying Drawings and described in the foregoing Detailed Description, it will be understood that the invention is not limited to the embodiment disclosed, but is capable of numerous rearrangements, modifications and substitutions without departing from the spirit of the invention as set forth and defined by the following claims.

What is claimed is:

1. A method for signal distribution, comprising the steps of:
receiving at a distributor a string of bytes;
applying a first rule at said distributor, said first rule comprising a matching step for finding a match between a part of said string of bytes and a pattern of bits, said first rule further comprising at least two results;
if a result of said first rule is a further rule, applying said further rule; and
if a result of said first rule is a destination, sending said string of bytes towards said destination.

2. The method of claim 1, wherein:
said first rule and any further rules are linked to form a decision tree; and
said decision tree is configured as per the needs of an application.

3. The method of claim 2 further comprising the steps of:
adding to the string of bytes, prior to sending said string of bytes towards said destination, an indication of a conclusion of said decision tree; and
using said conclusion at said destination.

4. The method of claim 1, wherein:
said method is used in a functionally divided network;
a subnetwork comprises at least two dissimilar functional units; and
said functionally divided network comprises at least two similar subnetworks.

5. The method of claim 1, wherein:
said method is used in a functionally replicated network; and
said functionally replicated network comprises at least two dissimilar functional unit groups, at least one of said at least two functional unit groups comprising at least two essentially identical functional units.

6. The method of claim 5, wherein:
a rule in said distributor dispatches consecutive strings of bytes to the functional units of a functional unit group in a manner that evens a load on said functional units; and
a rule in said distributor redistributes strings of bytes to operative functional units of a functional unit group when a given functional unit of said functional unit group is out of service.

7. The method of claim 1, wherein:
said destination is a special purpose functional unit used to add a feature of said special purpose functional unit to an application network; and
said distributor comprises rules for selecting said special purpose functional unit as the destination.

8. A distribution network, comprising:
a first distributor for:
receiving a string of bytes,
applying a first rule, said first rule comprising a matching step for finding a match between a part of said string of bytes and a pattern of bits, said first rule further comprising at least two results,
if a result of said first rule is a further rule, applying said further rule,
if a result of said first rule is a destination, sending said string of bytes towards said destination; and
a second distributor, said second distributor being said destination.

9. The distribution network of claim 8, wherein:
said first distributor and said second distributor comprise rules for forwarding said string of bytes through said distribution network until the string of bytes reaches a receiving functional unit.

10. The distribution network of claim 8, wherein:
said first distributor adds a conclusion to said string of bytes; and
said second distributor has a rule for using said conclusion.

11 .The distribution network of claim 8, wherein:
said first distributor further comprises a first decision tree;
said second distributor further comprises a second decision tree; and
rules in said first decision tree and rules in said second decision tree form a hierarchy of rules.

12. A distributor, comprising:
an input port for receiving a string of bytes from an origin;
an output port for forwarding said string of bytes towards a destination;
a decision tree comprising at least one rule, said at least one rule further comprising a pattern of bits and at least two results; and
a processor for matching a part of said string of bytes with said pattern of bits and for deciding one of said at least two results based on a matching outcome, any result of said at least two results being either a further rule or said destination.

13. The distributor of claim 12, wherein:
said decision tree has a memory for storing an identity of said destination when said string of bytes is part of a new session; and
said decision tree forwards said string of bytes according to said identity when said string of bytes is part of an ongoing session.

14. The distributor of claim 12, wherein:
said decision tree is an active decision tree, the distributor further comprising a preparation decision tree, said preparation decision tree comprising a copy of said at least one rule;
said processor further comprises a processor for updating said copy of said at least one rule;
said copy of said at least one rule, modified by said updating process, forms a new set of rules; and
said processor further comprises a commit process for replacing said active category with said new set of rules.
